(19) United States
(12) Patent Application Publication
(10) Pub. No.: US 2011/0182060 A1
(43) Pub. Date: Jul. 28, 2011

(54) ELECTRICAL CONNECTION DEVICE WITH LIGHTING FUNCTION AND FLEXIBLE TRANSMISSION LINE

(76) Inventor: Chia-Ching LIN, Taipei City (TW)

(21) Appl. No.: 12/693,939

(22) Filed: Jan. 26, 2010

(51) Int. Cl. F21V 33/00

(52) U.S. Cl. 362/184

(57) ABSTRACT

An electrical connection device with lighting function and flexible transmission line includes an insulated layer, at least one conducting wire, a flexible fixing wire, a first electrical connector, at least one light emitting diode, a reflection sheet, a battery seat, and a case. The flexible fixing wire and the conducting wire are located inside the insulated layer, and the flexible fixing wire makes the flexible transmission line presenting shape or position for user desired. The first electrical connector includes several conducting terminals and a printed circuit board, and the printed circuit board electrically connects the light emitting diode and the battery seat. Therefore, the electrical connection device further functions as setting position and lighting by properly using unused space of the electrical connection device, and the electrical connection device with lighting function and flexible transmission line could be a lamp for user.

### BACKGROUND OF THE INVENTION

1. Field of the Invention

The present invention is related to an electrical connection device with lighting function and flexible transmission line, and more particularly to an electrical connection device for lighting and setting position.

2. Description of Related Art

An electrical connector can be electrically connected between two electronic products as a medium. However, the electrical connector transferring signals collocates with a transmission line. Therefore, the transmission line is an essential unit in electronic industry. The transmission line could connect at least two electronic devices and transfer signals or electrical energy. Quality of the transmission line relates stability and service life of the electronic devices connecting the transmission line.

However, with the electrical connectors and computer peripheral devices highly developed, types and functions of the electrical connectors are also increasingly diverse. Some electronic devices need to be supported by positioning an appropriate place in order to achieve functions of the electronic devices (such as camera or microphone), however, the transmission line does not have supporting and positioning functions. For example, camera or microphone can be positioned by the other structures. Furthermore, the transmission line also has some problems, such as easy clutter and inconvenient cleaning.

Beside, unused space of the electrical connection device is still available. Thus, unused space of the electrical connection device could be added appropriate functions that make the electrical connection device more valuable and more useful for user.

Therefore, the invention provides an electrical connection device with lighting function and flexible transmission line to mitigate and/or obviate the aforementioned problems.

### SUMMARY OF THE INVENTION

A main object of the present invention is to provide an electrical connection device with lighting function and flexible transmission line. The electrical connection device functions as setting position and lighting by properly using unused space of the electrical connection device, and the electrical connection device with lighting function and flexible transmission line could be a lamp for user.

To achieve the above-mentioned object, an electrical connection device with lighting function and flexible transmission line in accordance with the present invention is provided, the electrical connection device with lighting function and flexible transmission line, comprising: an insulated layer; at least one conducting wire located inside the insulated layer; a flexible fixing wire located inside the insulated layer with the conducting wire; a first electrical connector comprising several conducting terminals and a printed circuit board, and the printed circuit board electrically connecting the terminals and one end of the conducting wire; at least one light emitting diode electrically connecting and located on the printed circuit board; a reflection sheet comprising at least one hole and located on the printed circuit board, and the light emitting diode located in the hole; a battery seat electrically connecting and located on the printed circuit board; and a case comprising an opening and covering for fixing the printed circuit board, the light emitting diode, the reflection sheet, and the batter seat, and position of the opening corresponding to the reflection sheet.

The electrical connection device with lighting function and flexible transmission line in the present invention provides the flexible fixing wire to make the flexible transmission line fixing on user desired position and forming user desired shape, and provides the battery seat setting battery to supply the light emitting diode with electrical energy.

For further understanding of the present invention, reference is made to the following detailed description illustrating the embodiments and examples of the present invention. The description is for illustrative purpose only and is not intended to limit the scope of the claim.

### BRIEF DESCRIPTION OF THE DRAWINGS

FIG. 1 is an exploded schematic view of a first embodiment of the present invention;

FIG. 2 is a schematic view of a first embodiment of the present invention;

FIG. 3 is a schematic view of a second embodiment of the present invention;

FIG. 4 is a schematic view of a third embodiment of the present invention;

FIG. 5 is a schematic view of a fourth embodiment of the present invention;

FIG. 6 is an used schematic view of a fourth embodiment of the present invention;

FIG. 7 is a schematic view of a fifth embodiment of the present invention.

### DETAILED DESCRIPTION OF THE PREFERRED EMBODIMENTS

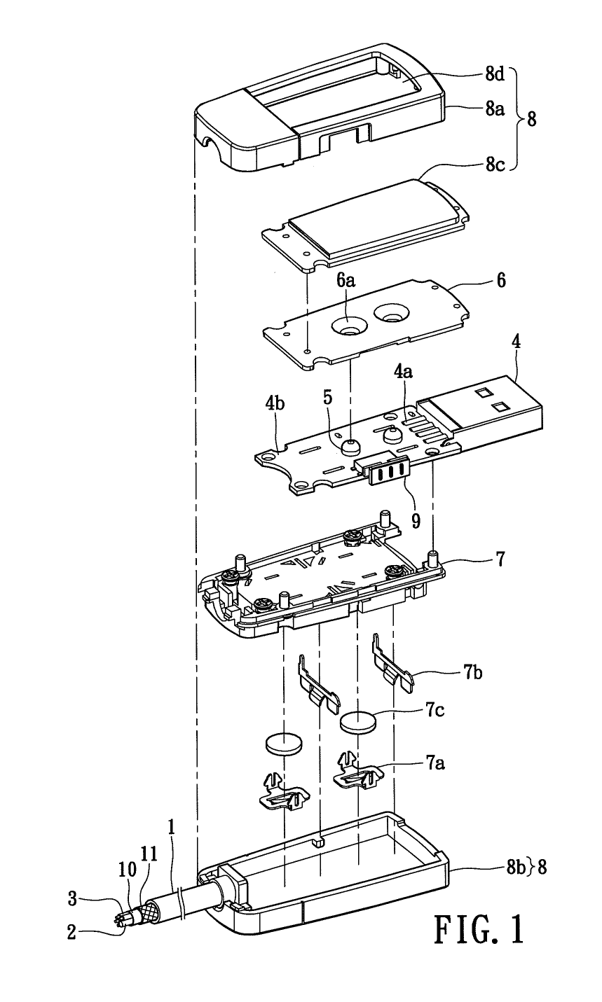

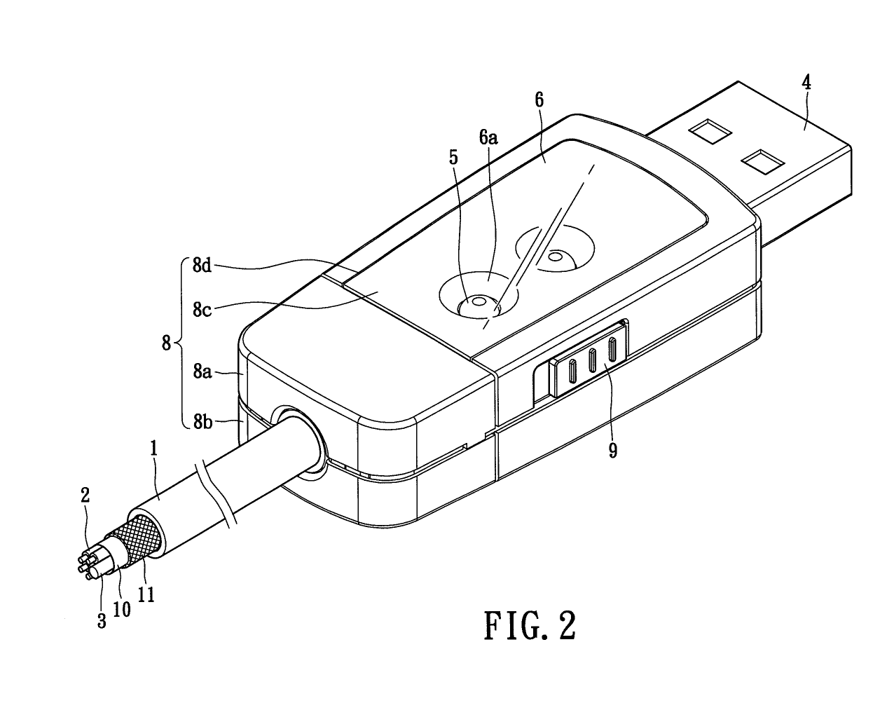

References are made to FIG. 1 and FIG. 2 illustrating a first embodiment of the present invention. The present invention is an electrical connection device with lighting function and flexible transmission line, including: an insulated layer 1, at least one conducting wire 2, a flexible fixing wire 3, a first electrical connector 4, at least one LED 5 (light emitting diode), a reflection sheet 6, a battery seat 7, a case 8, and a lighting switch 9.

The conducting wire 2 and the flexible fixing wire 3 are arranged inside the insulated layer 1. Further, the electrical connection device has an isolation layer 10 and a woven mesh 11 arranged inside the insulated layer 1. The isolation layer 10 covers the conducting wire 2 and the flexible fixing wire 3, and the woven mesh 11 covers the isolation layer 10. The flexible fixing wire 3 could be bent by users for making the flexible transmission line fixing to a desired position or folding as a desired shape.

The first electrical connector 4 includes several conducting terminal 4a and a PCB 4b (printed circuit board), and the PCB 4b includes a first circuit (not shown) and a second circuit (not shown). The first circuit electrically connects one end of the conducting wire 2 and the conducting terminals 4a. The LED 5 is located on the PCB 4b and electrically connects the second circuit. The reflection sheet 6 located on the PCB 4b includes at least one hole 6a, and the LED 5 is arranged in the hole 6a. The reflection sheet 6 would make light uniform and natural spread.

The battery seat 7 is located on the PCB 4b and electrically connects the second circuit. The battery seat 7 has at least one fixing element 7a and at least one resilient sheet 7b. The fixing element 7a makes batteries 7c setting in the battery seat 7 for more stable, and the resilient sheet 7b is provided as buffer and location between the battery seat 7 and the case 8. Battery 7c supplies electrical energy to LED 5 by the second circuit of the PCB 4b.

The case 8 covers and mounts the PCB 4b, the LED 5, the reflection sheet 6, and the batter seat 7. The case 8 includes an upper cover 8a, a lower cover 8b combining with the upper cover 8a, and a lens 8c. The upper cover 8a has an opening 8d formed on a surface thereof. The opening 8d is aligned with the reflection sheet, so that the lens 8c could be abutted against and sealed on the opening 8d. Therefore, light from the LED 5 producing and the reflection sheet 6 reflecting can be used on a place of user desired. In addition, the electrical connection device could raise lighting effect, but the size of the case 8 does not become larger.

The lighting switch 9 electrically connecting the second circuit is located on the PCB 4b and fixed on side of the case 8. User controls the lighting switch 9 to decide the second circuit conducted or not, and further controls battery 7c supplying electrical energy to the LED 5 or not. Beside, the lighting switch 9 properly uses unused space of the case 8, but the size of the case 8 does not become larger.

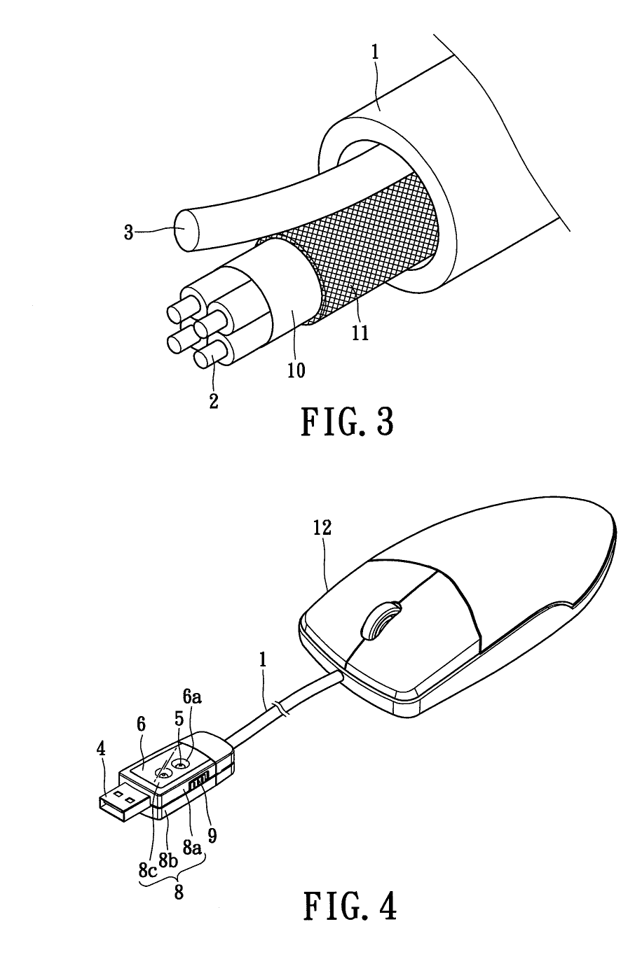

Please refer to FIG. 3 illustrating a second embodiment of the present invention. The isolation layer 10 covers the conducting wire 2, and the flexible fixing wire 3 is located between the woven mesh 11 and the insulated layer 1.

Please refer to FIGS. 1 and 4 illustrating a third embodiment of the present invention. Another end of the conducting wire 2 electrically connects a mouse 12. The mouse 12 could be a base, and the electrical connection device with lighting function and flexible transmission line would be a lamp. Furthermore, another end of the conducting wire 2 could electrically connect other electronic products.

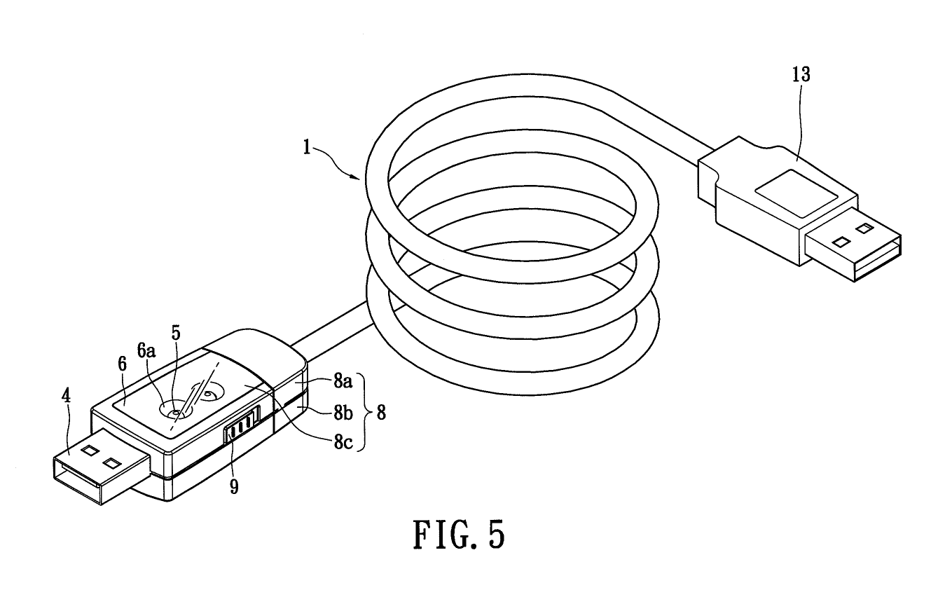

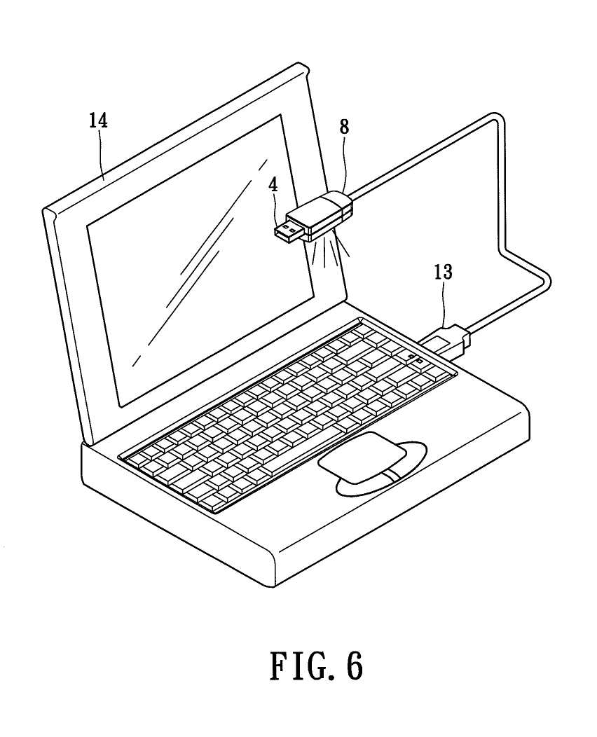

Please refer to FIGS. 1, 5 and 6 illustrating a fourth embodiment of the present invention. Another end of the conducting wire 2 electrically connects a second electrical connector 13, and the flexible transmission line could wrap around some object (not shown). Therefore, adjusting position and shape of the flexible fixing wire 3, the electrical connection device with lighting function and flexible transmission line would be a lamp for user. Additionally, the electrical connection device with lighting function and flexible transmission line could be a desk lamp or a table lamp, when the second electrical connector 13 connects a notebook 14 and the flexible fixing wire 3 is adjusted position and degree for user desired.

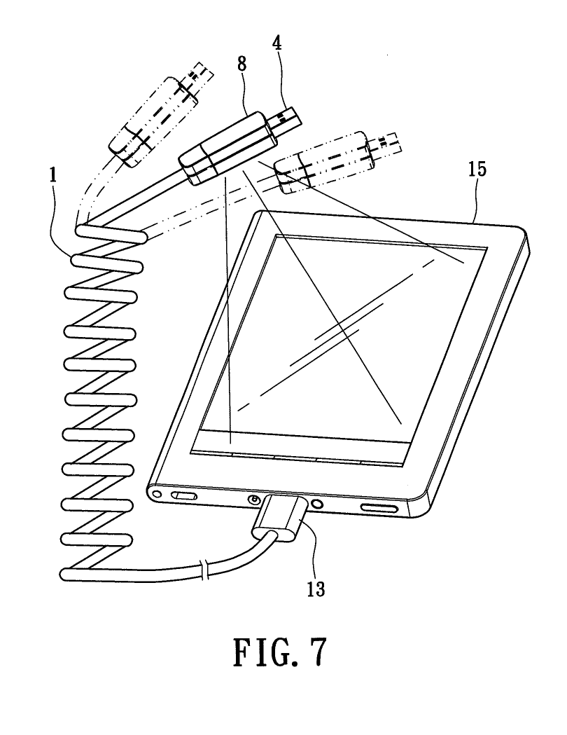

Please refer to FIGS. 1 and 7 illustrating a fifth embodiment of the present invention. The second electrical connector 13 would connect an e-book 15. The electrical connection device with lighting function and flexible transmission line could be a lamp, when the second electrical connector 13 connects the e-book 15 and the flexible fixing wire 3 is adjusted position and degree for user desired. Additionally, the second electrical connector 13 could connect computer (not shown), cell-phone (not shown), translation machine (not shown), and so on.

Consequently, the electrical connection device with lighting function and flexible transmission line of the present invention is provided that the LED 5 produces light by battery 7c supplies energy, and the reflection sheet 6 makes light uniform and natural spread. Furthermore, the flexible fixing wire 3 makes the flexible transmission line presenting user desired shape or user desired position. Thus, the electrical connection device with lighting function and flexible transmission line could be a lamp, and unused space of the electrical connection device would be added lighting function that makes the electrical connection device more valuable and more useful for user.

The description above only illustrates specific embodiments and examples of the present invention. The present invention should therefore cover various modifications and variations made to the herein-described structure and operations of the present invention, provided they fall within the scope of the present invention as defined in the following appended claims.

What is claimed is:

1. An electrical connection device with lighting function and flexible transmission line, comprising:
an insulated layer;
at least one conducting wire located inside the insulated layer;
a flexible fixing wire located inside the insulated layer with the conducting wire;
a first electrical connector comprising several conducting terminals and a printed circuit board, and the printed circuit board electrically connecting the terminals and the conducting wire;
at least one light emitting diode electrically connecting and located on the printed circuit board;
a reflection sheet comprising at least one hole and located on the printed circuit board, and the light emitting diode located in the hole;
a battery seat electrically connecting and located on the printed circuit board; and
a case comprising an opening aligned with the reflection sheet, and fixing and covering the printed circuit board, the light emitting diode, the reflection sheet, and the batter seat.

2. The electrical connection device as claimed in claim 1, further comprising an isolation layer located between the conducting wire and the insulated layer, for covering the conducting wire, and a woven mesh located outside the isolation layer.

3. The electrical connection device as claimed in claim 2, wherein the flexible fixing wire and the conducting wire are located inside the isolation layer, or the flexible fixing wire is located between the woven mesh and the insulated layer.

4. The electrical connection device as claimed in claim 1, wherein the conducting wire electrically connects an electronic product or a second electrical connector.

5. The electrical connection device as claimed in claim 4, wherein the second connector connects a notebook, an e-book, a computer, a cell-phone, or a translation machine.

6. The electrical connection device as claimed in claim 1, wherein the printed circuit board comprises a first circuit and a second circuit, the first circuit electrically connects the conducting terminals and the conducting wire, the second circuit electrically connects the light emitting diode and the battery seat.

7. The electrical connection device as claimed in claim 1, further comprising a lens abutted against and sealed on the opening of the case.

8. The electrical connection device as claimed in claim 1, wherein the case comprises an upper cover and a lower cover combined with the upper cover, and the opening is formed on the upper cover.

9. The electrical connection device as claimed in claim 1, wherein the printed circuit board electrically connects a lighting switch, and the lighting switch is disposed on the printed circuit board and fixed on a side of the case.

10. The electrical connection device as claimed in claim 1, wherein the battery seat has at least one fixing element and at least one resilient sheet.
